(19) United States
(12) Patent Application Publication
(10) Pub. No.: US 2008/0226052 A1
(43) Pub. Date: Sep. 18, 2008

(54) Method And System For Adding A Background Tone To A Call

(75) Inventors: Liyan Peng, Shenzhen (CN); Shengqiong Wang, Shenzhen (CN); Nan Sun, Shenzhen (CN); Rongrong Yu, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 11/672,278

(22) Filed: Feb. 7, 2007

Related U.S. Application Data
(63) Continuation of application No. PCT/CN05/00403, filed on Mar. 29, 2005.

(30) Foreign Application Priority Data
Aug. 12, 2004 (CN) 200410055176.3

(51) Int. Cl. H04M 3/42

(52) U.S. Cl. 379/207.02

(57) ABSTRACT

A method for adding a background tone to a call includes: triggering a background tone service, according to a preset triggering mechanism, upon receipt of a call from a calling subscriber to a called subscriber; establishing a three-party call among the calling subscriber, the called subscriber, and the background tone service platform, and playing, by the background tone, a background tone service platform. A system for implementing a background tone service includes an exchange and a background tone service platform. By applying embodiments of the present invention, subscribers can communicate with each other and enjoy the background tone, which is more interesting.

### CROSS-REFERENCE TO RELATED APPLICATIONS

This application is a continuation of International Application No. PCT/CN2005/000403 filed on Mar. 29, 2005. This application claims the benefit of Chinese Application No. 200410055176.3 filed on Aug. 12, 2004. The disclosures of the above applications are incorporated herein by reference.

### FIELD

The present disclosure relates to communication technologies, and more particularly, to a method and system for adding a background tone to a call.

### BACKGROUND

The statements in this section merely provide background information related to the present disclosure and may not constitute prior art.

Along with the development of communication system, people put forward various requirements; for example, wish to add a sound which is not generated by call parties as a background tone to a call to make the atmosphere of the call lively, without disturbing the current call. The background tone may be an animal call, popular joking words, a sound of water in a toilet, various laughter, a grotesque and laughable wildness effect sound, an atmosphere effect sound, an occasion effect sound such as wedding, sound of emotion profession, a sound of amativeness profession, a sound of sweet profession, music, a song and the like. By adding a background tone to a call, the atmosphere between call parties may be glamorized to make the call distinctive.

Moreover, since existing exchanges may support a multi-party call, a call among multiple subscribers may be established by an exchange. In addition, the multiparty service may also be implemented through an Intelligent Peripheral/Advanced Intelligent Peripheral (IP/AIP). For instance, in a current conference phone service, an IP/AIP establishes a site and adds associated subscribers to the established site to implement a multiparty service.

However, at present, there is still not a method and a system for adding a background tone to a call during the call.

### SUMMARY

Embodiments of the present invention provide a method and system for adding a background tone to a call to enable subscribers to communicate with each other accompanied by a background tone, which will be more interesting.

A method for adding a background tone to a call includes:

triggering a background tone service, according to a preset triggering mechanism upon receipt of a call from a calling subscriber to a called subscriber;

establishing a three-party call among the calling subscriber, the called subscriber and a background tone service platform;

playing, by the background tone service platform, a background tone.

The triggering mechanism includes: triggering the background tone service according to a service access code; and

the process of triggering the background tone service further includes:

determining that the call carries the service access code for triggering the background tone service.

The triggering mechanism includes: for the calling subscriber, triggering the background tone service according to subscription information; and

the process of triggering the background tone service further includes:

determining that the subscription information of background tone service for the calling subscriber is recorded.

The triggering mechanism includes: for the called subscriber, triggering the background tone service according to subscription information; and

the process of triggering the background tone service further includes:

determining that the subscription information of background tone service for the called subscriber is recorded.

The method further includes:

receiving, by the background tone service platform, keystroke information of the calling subscriber or called subscriber; and playing a background tone or adjusting volume of the background tone according to the keystroke information received.

A system for adding a background tone to a call includes:

an exchange for triggering a background tone service according to a preset triggering mechanism, and connecting a call of a calling subscriber;

a background tone service platform for receving the call connected by the exchange establishing a three-party call among the calling subscriber and a called subscriber and the background tone service platform, and playing a background tone during the three-party call.

The background tone service platform includes:

an IP/AIP for establishing a site for the three-party call, and adding the calling subscriber to the site; and initiating a call to the called subscriber, establishing a connection from the IP/AIP to the called subscriber, and adding the called subscriber to the site established by the IP/AIP.

A system for adding a background tone to a call includes:

a background tone service platform for playing a background tone during the three-party call;

an exchange for triggering a background tone service according to a preset triggering mechanism upon receipt of call information from the calling subscriber, and establishing a three-party call among the calling subscriber, the called subscriber and the background tone service platform.

The background tone service platform includes: an IP/AIP; and

the exchange is used for routing the call to the IP/AIP upon receipt of call information from the calling subscriber, and establishing a connection from the calling subscriber to the IP/AIP;

the IP/AIP instructing the exchange to keep the connection established from the calling subscriber to the IP/AIP; initiating a call to the called subscriber through the exchange, establish a connection from the exchange to the called subscriber; and instructing the exchange to set the connection from the exchange to the IP/AIP, the connection from the exchange to the called subscriber, and the connection from the exchange to the calling subscriber as the three-party call.

A system for adding a background tone to a call includes:

an exchange for triggering a background tone service according to a preset triggering mechanism, and reporting triggering information of background tone service;

an SCP for receiving the triggering information of background tone service reproted by the exchange, and instructing the exchange to connect the call from the subscriber according to the background tone service logic stored in the SCP;

a background tone service platform for receiving the call, establishing a three-party call among the calling subscriber, the called subscriber and the background tone service platform, storing and playing a background tone in the three-party call.

The background tone service platform includes:

an IP/AIP for establishing a site for the three-party call, and adding the calling subscriber to the site; initiating a call to the called subscriber, establishing a connection from the IP/AIP to the called subscriber, and adding the called subscriber to the site established by the IP/AIP.

It can be seen from the above solutions, the method for adding a background tone to a call provided by an embodiment of the present invention, implements playing a background tone which is not generated by the call parties during the call through a three-party technique, thereby glamorizing the monotone call by which only the other party's sound can be heard. The background tone may temper the atmosphere between the call parties or provide a virtual sound for the call parties, thereby making daily calls more interesting. Further, a suitable background tone can be used in a call for congratulation to enhance or glamorize the atmosphere, thereby making the call more interesting. The background tone service is a new value-added service having a high applicable value.

In addition, a system for adding a background tone to a call provided by an embodiment of the present invention may use an IP/AIP capable of performing a three-party call as a background tone service platform, which only needs to overlay an entity on the existing network in order to rapidly develop the background tone service. Or, an entity which is a combination of an exchange and an IP/AIP can serve as a background tone service platform without voice channel circuitousness. Additionally, an SCP may be introduced to develop the background tone service for the called subscriber as well.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating a system for implementing a background tone service in accordance with an embodiment of the present invention.

FIG. 2 is a schematic diagram illustrating a system for implementing a background tone service in accordance with a first embodiment of the present invention.

FIG. 3 is a flow chart of implementing a background tone service in accordance with the first embodiment of the present invention.

FIG. 4 is a schematic diagram illustrating a system for implementing a background tone service in accordance with a second embodiment of the present invention.

FIG. 5 is a flow chart of implementing a background tone service in accordance with the second embodiment of the present invention.

FIG. 6 is a schematic diagram illustrating a system for implementing a background tone service in accordance with a third embodiment of the present invention.

FIG. 7 is a flow chart of implementing a background tone service in accordance with the third embodiment of the present invention.

FIG. 8 is a flow chart of implementing a background tone service triggered by a called subscriber in accordance with an embodiment of the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Embodiments of the present invention are hereinafter described in detail with reference to the accompanying drawings.

According to the schematic diagram illustrating the system for implementing a background tone service as shown in FIG. 1, a network side at least includes an exchange and a background tone service platform. The exchange which may be an SSP/MSC or the like is used for accessing and connecting a call of a subscriber. The background tone service platform is utilized to store background tone data, play the background tone and provide a three-party call, thereby adding the background tone service platform as one party to the call between a calling subscriber and a called subscriber. The background tone service platform may be implemented by the exchange and an Advanced Intelligent Peripheral (AIP) together, wherein the exchange implements the three-party call and the AIP stores the background tone data and plays the background tone. The background tone service platform may be solely implemented by the AIP capable of performing the three-party call as well. The above-mentioned AIP may be an Intelligent Peripheral (IP) and there will be no more description hereinafter.

Further, the background tone service platform allows a user to access so as to manage audio files of background tone services. For instance, a content provider is allowed to access the background tone service platform by Web or the like to submit an audio file of a background tone; a network operator is allowed to review the audio file submitted by the content provider and load the audio file into the background tone service platform; and a terminal subscriber is allowed to set and manage his/her personal audio library, and to apply for or logout a background tone service.

The method for adding a background tone service to a call in accordance with an embodiment of the present invention mainly includes the following processes: a calling subscriber calls a called subscriber; upon receipt of the call, the network side, according to a preset triggering mechanism, triggers a background tone service, invokes a background tone service platform, and establishes a three-party call among the calling subscriber, the background tone service platform and the called subscriber; the background tone service platform plays the background tone; furthermore, the network side, according to keystroke information submitted by the subscriber triggering the service, chooses a background tone or adjusts the volume of the background tone; finally, the network side releases the connections among the three call parties when the call is terminated.

The triggering mechanism is that the background tone service is triggered according to the service access number carried by the call initiated by the calling subscriber, or, the calling subscriber or called subscriber triggers the background tone service according to the background tone service subscription information preset by the calling subscriber or called subscriber. A background tone service triggered for the calling subscriber and background tone service triggered for the called subscriber may be developed respectively according to the calling subscriber triggering and the called subscriber triggering.

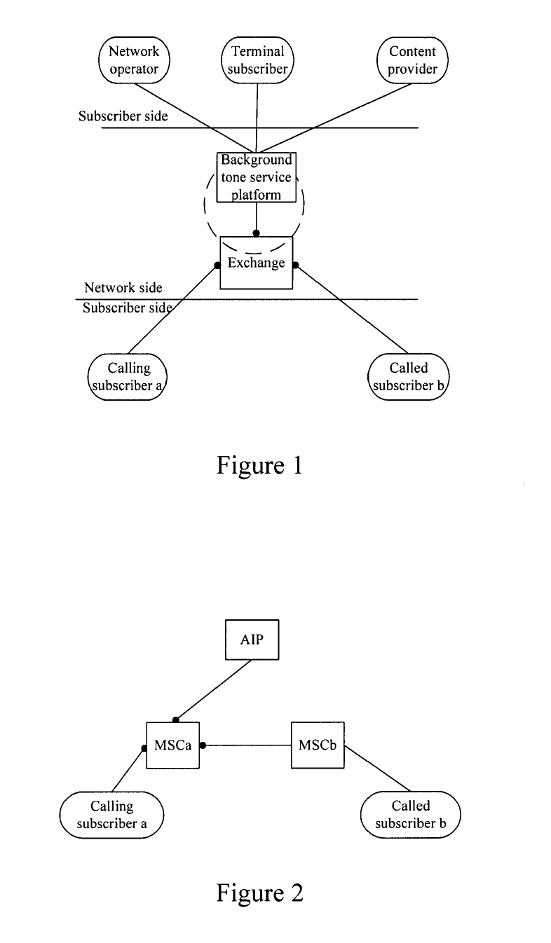

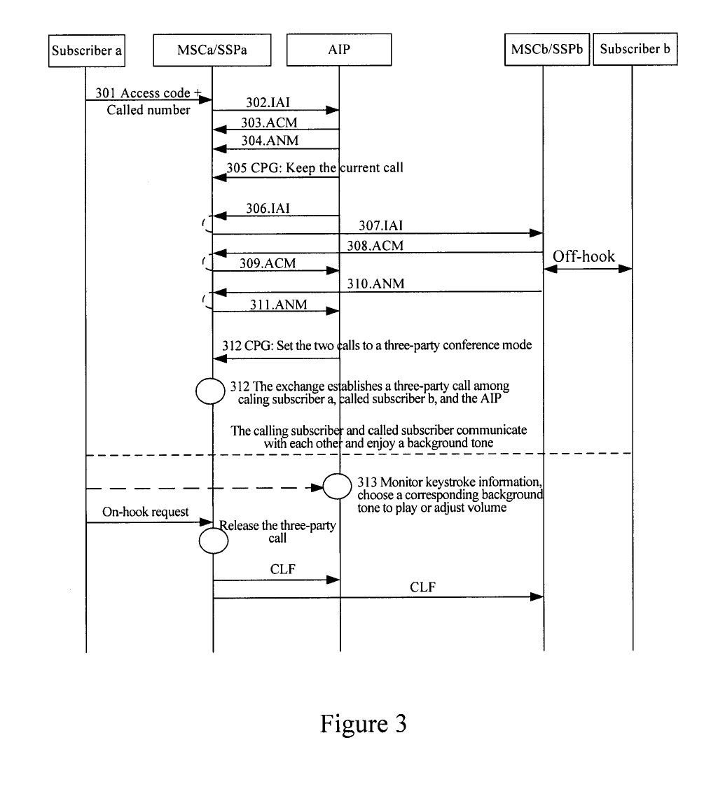

According to the schematic diagram illustrating the system for implementing a background tone service in accordance with the first embodiment of the present invention as shown in FIG. 2, the background tone service platform may be implemented by an exchange and an AIP together, wherein the exchange is MSCa. The exchange is utilized to implement a three-party call, that is, implement the three-party call among a calling subscriber, a called subscriber and the background tone service platform; while the AIP is used for playing the background tone during the call of calling subscriber and called subscriber. A detail description will be given by taking calling subscriber a performing a background tone service as an example and with reference to the flow chart of implementing a background tone service in accordance with the first embodiment of the present invention as shown in FIG. 3. In the first embodiment, the exchange is an MSC, and a service access code for triggering a background tone service needs to be preset in the exchange; the first embodiment further includes the following processes.

Process 301: calling subscriber a dials and submits the service access code +a called number b to MSCa.

Processes 302-304: upon receipt of the service access code+the called number b transferred from calling subscriber a, MSCa routes the call initiated by calling subscriber a to the AIP according to the service access code, initiates a call to the AIP, and establishes a connection from MSCa to the AIP upon receiving an off-hook Answer Message (ANM) returned by the AIP, wherein MSCa transfers the called number b to the AIP through an Initial Address message with additional Information (IAI). In this procedure, the AIP is similar to a terminal subscriber and performs automatic answer.

Process 305: the AIP transfers a Call Progress (CPG) message to MSCa to instruct MSCa to keep the voice channel established by MSCa from calling subscriber a to the AIP.

Processes 306-311: the AIP, according to the called number b received, initiates a call to called subscriber b through MSCa, and establishes a voice channel from the AIP to called subscriber b after the off-hook event of called subscriber b is detected.

Process 312: the AIP sends the CPG message to MSCa to instruct MSCa to set the two voice channels, i.e. calling subscriber a to MSCa to the AIP, and called subscriber b to MSCb to MSCa to the AIP, in a three-party conference mode. MSCa establishes a three-party call among calling subscriber a, called subscriber b and the AIP. And calling subscriber a and called subscriber b may talk to each other; meanwhile, the AIP plays a background tone.

Process 313: the AIP monitors keystroke information submitted by calling subscriber a and plays the background tone according to the keystroke information received or adjusts the volume of the background tone. For example, when calling subscriber a presses a number key 0˜9, the system will play the background tone according to the keystroke information received by the AIP. If the calling subscriber presses functional key # or *, the system will turn up or turn down the volume of background tone. It is easy to understand that the AIP may monitor the keystroke information submitted from called subscriber b and play a background tone or adjust the volume of the background tone accordint to the keystroke information received by the AIP.

It may be seen that, the three-party call among the calling subscriber, the called subscriber and the AIP is established at an originating exchange, thereby implementing the function of adding a background tone played by the AIP to the call during the call of the calling subscriber and the called subscriber, and enabling the AIP to play a background tone according to the keystroke information of a subscriber. When the call is terminated, that is, an on-hook event of a certain subscriber is detected, MSCa terminates the three-party call and releases the connections established at originating exchange.

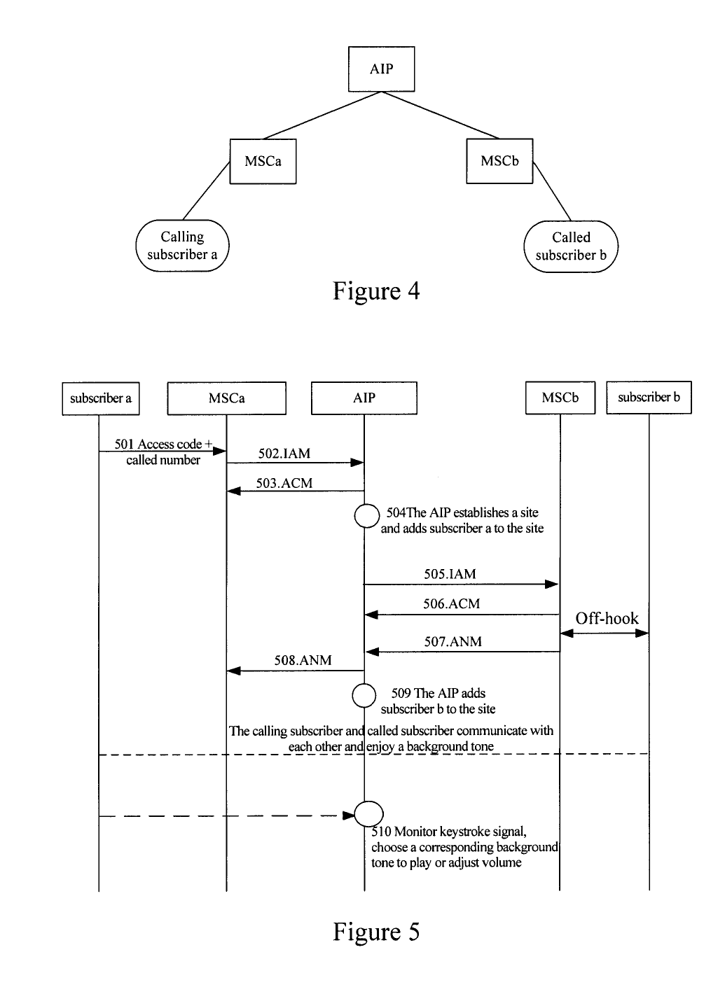

According to the schematic diagram illustrating a system for implementing a background tone service in accordance with the second embodiment of the present invention as shown in FIG. 4, the background tone service platform may be implemented by an AIP capable of performing a three-party call. When this manner is adopted, the method for implementing a three-party call is the same as that used by a current mature conference phone system, that is, implementing the three-party call by establishing, through the AIP, a site for a multiparty service. A detailed description will be given by taking a background tone service for a calling subscriber as an example and with reference to the flow chart of implementing a background tone service in accordance with the second embodiment of the present invention as shown in FIG. 5. In the second embodiment, the exchange herein is an MSC, and a service access code for triggering a background tone service needs to be preset in the exchange; the second embodiment includes the following processes.

Process 501: calling subscriber a dials and submits the service access code +a called number b to MSCa.

Processes 502-503: upon receipt of the service access code and the called number b submitted by calling subscriber a, MSCa routes the call initiated by calling subscriber a to the AIP according to the access code and transfers an Initial Address Message (IAM) including the called number b to the AIP. The AIP returns an Address Complete Message (ACM).

Process 504: the AIP establishes a site for a three-party call and adds calling subscriber a to the site. With respect to the procedure of establishing the site, the technical specification related with the IP/AIP technique or the technique for implementing a multipoint conference may be referred to, so there is no more description herein.

Processes 505-509: the AIP, according to the called number b received, initiates a call to called subscriber b through MSCb, establishes a voice channel from the AIP to called subscriber b after the off-hook event of called subscriber b is detected, and adds called subscriber b to the established site. Moreover, the AIP adds itself as the third party to the site established by the AIP to implement a three-party call among the AIP, calling subscriber a, and called subscribed B. And, calling subscriber a and called subscriber b may talk to each other; and the AIP plays a background tone.

Process 510 is the same as Process 313, there is consequently no more description. When the call is terminated and thus an on-hook event of a certain subscriber is detected, the AIP terminates the three-party call, releases the connections established by the AIP, and terminates the site established by the AIP.

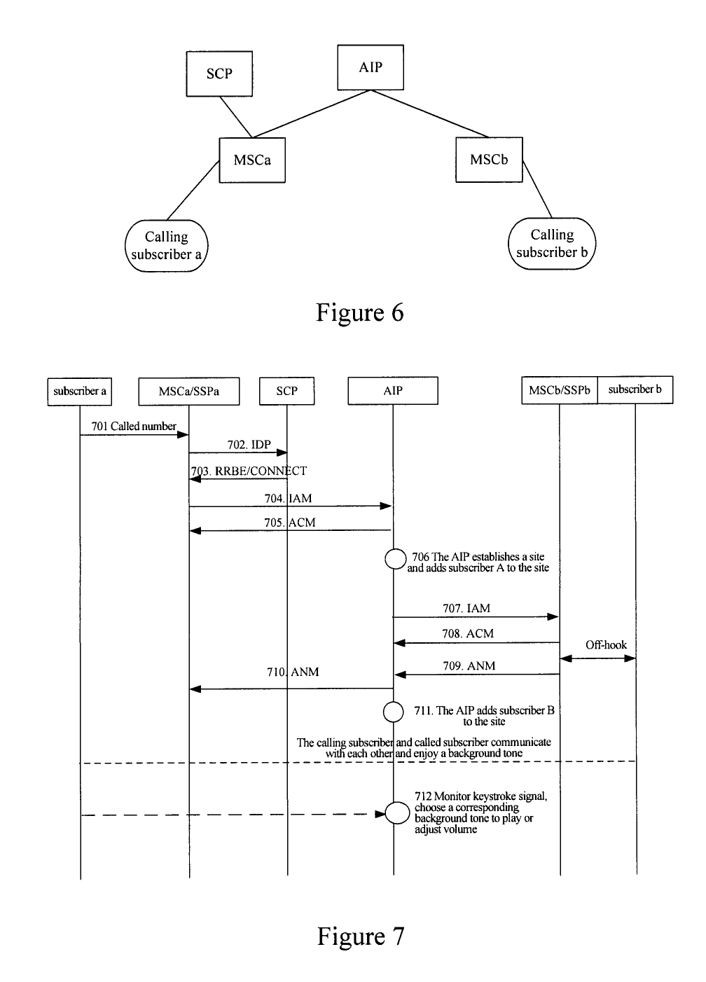

The foregoing description is just the manner of triggering a background tone service by dialling a service access code. In addition, a manner of triggering a background tone service by using service subscription information may be used as well. When the subscription information is used for triggerring a background tone service, the calling subscriber may directly dial the called number without additionally dialling the service access code. It may be seen that, with reference to the schematic diagram illustrating a system for implementing a background tone in accordance with the third embodiment of the present invention as shown in FIG. 6, the manner of triggering a background tone service by using subscription information may be implemented in the third embodiment. Compared with the above-mentioned system architecture for implementing a background tone service, the network side needs to add an SCP which stores background tone service logic; the SCP issues the background tone service logic, and instucts the exchange to handle a call by exchanging information with the exchange. Moreover, it is needed to pre-register, on the exchange or a Home Location Register (HLR), the subscription information of the subscriber using the background tone service. With reference to the flow chart of implementing a background tone service in accordance with the third embodiment of the present invention as shown in FIG. 7, the exchange is an MSC and calling subscriber a is a registered subscriber; the embodiment includes the following steps.

Process 701: calling subscriber a which has registered the background tone service dials a called number b and submits the called number b to MSCa.

Processes 702-703: MSCa obtains the subscription information of calling subscriber a from the HLR, triggers a background tone service according to the subscription information of calling subscriber a, and reports an IDP (initial detection point) message to the SCP. The SCP issues a connection (CONNECT) operation to MSCa according to the recorded background tone service logic to instruct MSCa to connect the call from calling subscriber a to the AIP.

Processes 704-712 are the same as Processes 502-510, there is no more description herein.

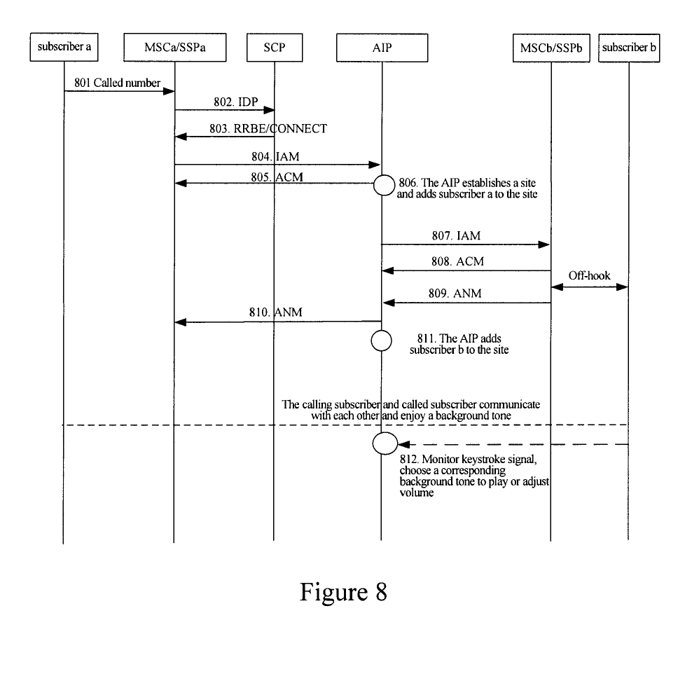

Additionally, when the subscription information is used for triggering the background tone service, it is easy to understand by those skilled in the art that a manner of triggering by a called subscriber may also be adopted. With reference to the flow chart of adding a background tone to a call by triggering a background tone service by called subscriber as shown in FIG. 8, it can be seen that the procedure of triggering a background tone service at MSCa according to the subscription information corresponding to the called number received is the same as the procedure of triggering a background tone service by the calling subscriber, there is no more description herein.

The advantage of the above-mentioned solution of perform a three-party call by an exchange is that there is no voice channel circuitousness. With respect to the solution of performing a three-party call by an AIP, the advantage of the solution lies in that a new entity is directly overlaid on the existing network, which needs low cost and light workload but supports a large amount of traffic.

The network operator may choose different solutions combining the condition of an existing network according to demands. Generally, at the initial stage of developing the service, that is, the amount of traffic is not very large, the AIP may be chosen to implement a three-party call since it can activate a service rapidly just by overlaying a background tone service platform on the existing network, thereby fostering a market quickly. After the market is mature, using an exchange to implement a three-party call may be considered, at this piont, the exchange needs to be reconstructed to support a three-party call with a large amount of traffic. Since there is no voice channel circuitousness when the exchange is used for implementing a three-party call, the period of establishing a call may be shortened and the quality of the service can be improved.

The foregoing descriptions are only preferred embodiments of the present invention and are not for use in limiting the protection scope thereof. All the modifications, equivalent replacements or improvements in the scope of the present invention's sprit and principles shall be included in the protection scope of the present invention.

What is claimed is:

1. A method for adding a background tone to a call, comprising:
triggering a background tone service, according to a preset triggering mechanism, upon receipt of a call from a calling subscriber to a called subscriber;
establishing a three-party call among the calling subscriber, the called subscriber and a background tone service platform;
playing, by the background tone service platform, a background tone.

2. The method of claim 1, wherein the triggering mechanism comprises: triggering the background tone service according to a service access code; and
the process of triggering the background tone service further comprises:
determining that the call carries the service access code for triggering the background tone service.

3. The method of claim 1, wherein the triggering mechanism comprises:
for the calling subscriber, triggering the background tone service according to subscription information; and
the process of triggering the background tone service further comprises:
determining that the subscription information of background tone service for the calling subscriber is recorded.

4. The method of claim 1, wherein the triggering mechanism comprises:
for the called subscriber, triggering the background tone service according to subscription information; and
the process of triggering the background tone service further comprises:
determining that the subscription information of background tone service for the called subscriber is recorded.

5. The method of claims 1, further comprising:
receiving, by the background tone service platform, keystroke information of the calling subscriber or called subscriber; and playing a background tone or adjusting volume of the background tone according to the keystroke information received.

6. The method of claims 2, further comprising:
receiving, by the background tone service platform, keystroke information of the calling subscriber or called subscriber; and playing a background tone or adjusting volume of the background tone according to the keystroke information received.

7. The method of claims 3, further comprising:
receiving, by the background tone service platform, keystroke information of the calling subscriber or called subscriber; and playing a background tone or adjusting volume of the background tone according to the keystroke information received.

8. The method of claims 4, further comprising:
receiving, by the background tone service platform, keystroke information of the calling subscriber or called subscriber; and playing a background tone or adjusting volume of the background tone according to the keystroke information received.

9. A system for adding a background tone to a call, comprising:
an exchange for triggering a background tone service according to a preset triggering mechanism, and connecting a call of a calling subscriber;
a background tone service platform for receving the call connected by the exchange, establishing a three-party call among the calling subscriber and a called subscriber and the background tone service platform, and playing a background tone during the three-party call.

10. The system of claim 9, wherein the background tone service platform comprises:
an IP/AIP for establishing a site for the three-party call, and adding the calling subscriber to the site; and initiating a call to the called subscriber, establishing a connection from the IP/AIP to the called subscriber, and adding the called subscriber to the site established by the IP/AIP.

11. A system for adding a background tone to a call, comprising:
a background tone service platform for playing a background tone during the three-party call;
an exchange for triggering a background tone service according to a preset triggering mechanism upon receipt of call information from the calling subscriber, and establishing a three-party call among the calling subscriber, the called subscriber and the background tone service platform.

12. The system of claim 11, wherein the background tone service platform comprises:
an IP/AIP; and
the exchange is used for routing the call to the IP/AIP upon receipt of call information from the calling subscriber, and establishing a connection from the calling subscriber to the IP/AIP;
the IP/AIP instructing the exchange to keep the connection established from the calling subscriber to the IP/AIP; initiating a call to the called subscriber through the exchange, establish a connection from the exchange to the called subscriber; and instructing the exchange to set the connection from the exchange to the IP/AIP, the connection from the exchange to the called subscriber, and the connection from the exchange to the calling subscriber as the three-party call.

13. A system for adding a background tone to a call, comprising:
an exchange for triggering a background tone service according to a preset triggering mechanism, and reporting triggering information of background tone service;
an SCP for receiving the triggering information of background tone service reproted by the exchange, and instructing the exchange to connect the call from the subscriber according to the background tone service logic stored in the SCP;
a background tone service platform for receiving the call, establishing a three-party call among the calling subscriber, the called subscriber and the background tone service platform, storing and playing a background tone in the three-party call.

14. The system of claim 13, wherein the background tone service platform comprises:
an IP/AIP for establishing a site for the three-party call, and adding the calling subscriber to the site; initiating a call to the called subscriber, establishing a connection from the IP/AIP to the called subscriber, and adding the called subscriber to the site established by the IP/AIP.
